(19) United States
(12) Patent Application Publication
(10) Pub. No.: US 2017/0277559 A1
(43) Pub. Date: Sep. 28, 2017

(54) CLASSIFYING WORK PROCESSES

(71) Applicant: DAQRI, LLC, Los Angeles, CA (US)

(72) Inventor: Brian Mullins, Altadena, CA (US)

(21) Appl. No.: 15/081,309

(22) Filed: Mar. 25, 2016

(51) Int. Cl. G06F 9/48

(52) U.S. Cl. CPC G06F 9/48; G06T 19/006

(57) ABSTRACT

A system and method for classifying tasks are described. A server receives first sensor data from an augmented reality (AR) device and second sensor data from a first machine detected by the AR device. The first and second sensor data are related to a user of the AR device operating the first machine. The server identifies a task of the user based on the first and second sensor data. A task result of the user of the AR device operating the first machine is determined. The server accesses task patterns and corresponding levels of difficulty related to the first machine and determines a difficulty of the task based on a comparison of the task, the task result, and the task patterns and corresponding levels of difficulty. The AR application generates AR content based on the task and the difficulty of the task.

### TECHNICAL FIELD

The subject matter disclosed herein generally relates to the processing of data. Specifically, the present disclosure addresses systems and methods for classifying a user work process.

### BACKGROUND

A device can be used to generate and display data in addition to an image captured with the device. For example, augmented reality (AR) is a live, direct or indirect view of a physical, real-world environment whose elements are augmented by computer-generated sensory input such as sound, video, graphics, or Global Positioning System (GPS) data. With the help of advanced AR technology (e.g., adding computer vision and object recognition) the information about the surrounding real world of the user becomes interactive. Device-generated (e.g., artificial) information about the environment and its objects can be overlaid on the real world.

### BRIEF DESCRIPTION OF THE DRAWINGS

Some embodiments are illustrated by way of example and not limitation in the figures of the accompanying drawings.

FIG. 1 is a block diagram illustrating an example of a network suitable for classifying work processes, according to some example embodiments.

FIG. 2 is a block diagram illustrating an example embodiment of modules (e.g., components) of an augmented reality (AR) device.

FIG. 3 is a block diagram illustrating an example embodiment of modules of a recognition module.

FIG. 4 is a block diagram illustrating an example embodiment of modules of a machine learning module.

FIG. 5 is a block diagram illustrating an example embodiment of modules of a server.

FIG. 6 is a block diagram illustrating an example embodiment of modules of a task classification engine.

FIG. 7 is a ladder diagram illustrating an example embodiment of an operation of work process classification.

FIG. 8 is a ladder diagram illustrating another example embodiment of an operation of work process classification.

FIG. 9 is a flowchart illustrating an example operation of generating AR content based on a work process classification.

FIG. 10 is a flowchart illustrating another example operation of generating AR content based on a work process classification.

FIG. 11 is a diagram illustrating an example operation of classifying a work process and generating AR content based on the classification of the work process.

FIG. 12 is a block diagram illustrating components of a machine, according to some example embodiments, able to read instructions from a machine-readable medium and perform any one or more of the methodologies discussed herein.

FIG. 13 is a block diagram illustrating a mobile device, according to an example embodiment.

### DETAILED DESCRIPTION

Example methods and systems are directed to classification of work processes. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A machine learning approach is used to classify tasks (e.g., repairing an engine valve) and interactions (e.g., removing a cover, flipping a switch) between machines (e.g., engine) and users based on the combination of machine sensor data (e.g., data from sensors at the engine) and computer vision techniques. By combining the information on how a user is interacting with physical objects such as a machine, a tool, or components of a machine (e.g., by using computer vision and sensors from both an augmented reality (AR) device (worn by the user) and the machine); the machine's behavior (e.g., by using sensor data in the machine); and the results (e.g., by using sensor data from both the AR device and the machine), the difficulty of interacting with the machine and the AR device user's skill level can be assessed. Furthermore, the information from the sensors can be used to classify the “work”, task, and level of difficulty involved with the task based on a library of previously identified patterns, sensor data, and outcomes. AR content can be generated and customized based on the task of the user and the level of difficulty of the task.

The AR device uses an AR application that allows the user to experience information, such as in the form of a virtual object such as a three-dimensional virtual object overlaid on an image of a physical object captured with a camera of the AR device. In the case of a transparent display, the three-dimensional virtual object is displayed in a line of sight of the user and the physical object. The physical object includes a visual reference (e.g., a recognized image, pattern, or object) that the AR application can identify. A visualization or display of the additional information, such as the three-dimensional virtual object overlaid or engaged with an image of the physical object, is generated in a display of the AR device. The three-dimensional virtual object may be selected based on the recognized visual reference or captured image of the physical object. A rendering of the visualization of the three-dimensional virtual object may be based on a position of the display relative to the visual reference. The virtual object may include a three-dimensional or two-dimensional virtual object. For example, the three-dimensional virtual object may include a three-dimensional view of a hammer. The two-dimensional virtual object may include a two-dimensional view of a dialog box or menu, or written information such as statistics information for properties or physical characteristics of the object (e.g., temperature, operating status). An image of the virtual object may be rendered at the AR device or at a server in communication with the AR device.

A system and method for classifying work (e.g., tasks) are described. A server receives first sensor data from an AR device and second sensor data from a first machine detected by the AR device. The first and second sensor data are related to a user of the AR device operating the first machine. The server identifies a task of the user based on the first and second sensor data. A task result of the user of the AR device operating the first machine is determined. The server accesses task patterns and corresponding levels of difficulty related to the first machine and determines a difficulty of the task based on a comparison of the task, the task result, and the task patterns and corresponding levels of difficulty. The server generates AR content based on the task and the difficulty of the task.

In another example embodiment, a non-transitory machine-readable storage device may store a set of instructions that, when executed by at least one processor, causes the at least one processor to perform the method operations discussed within the present disclosure.

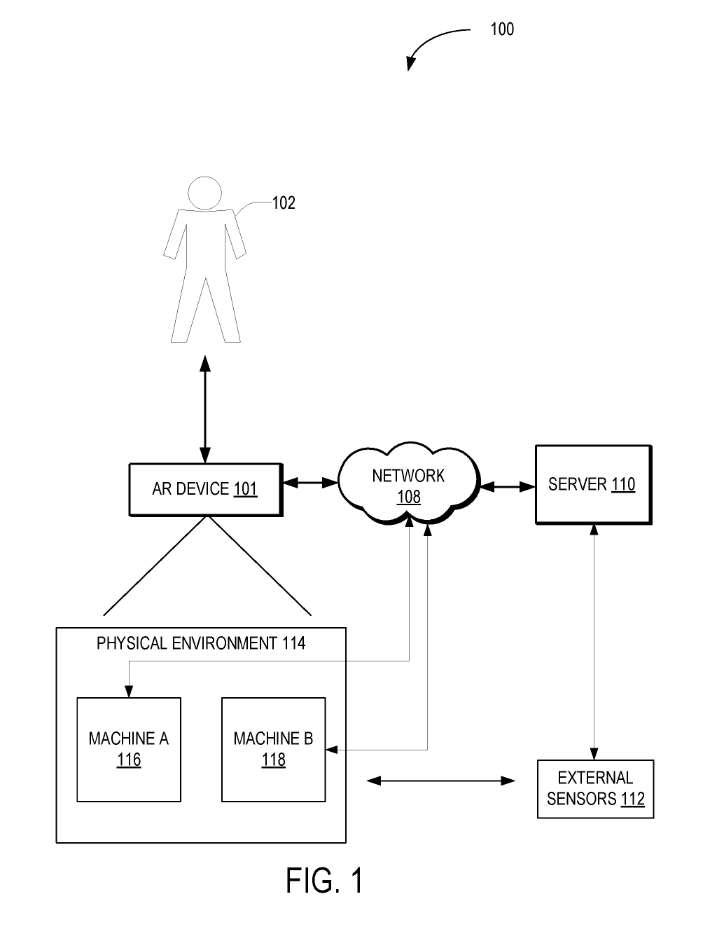

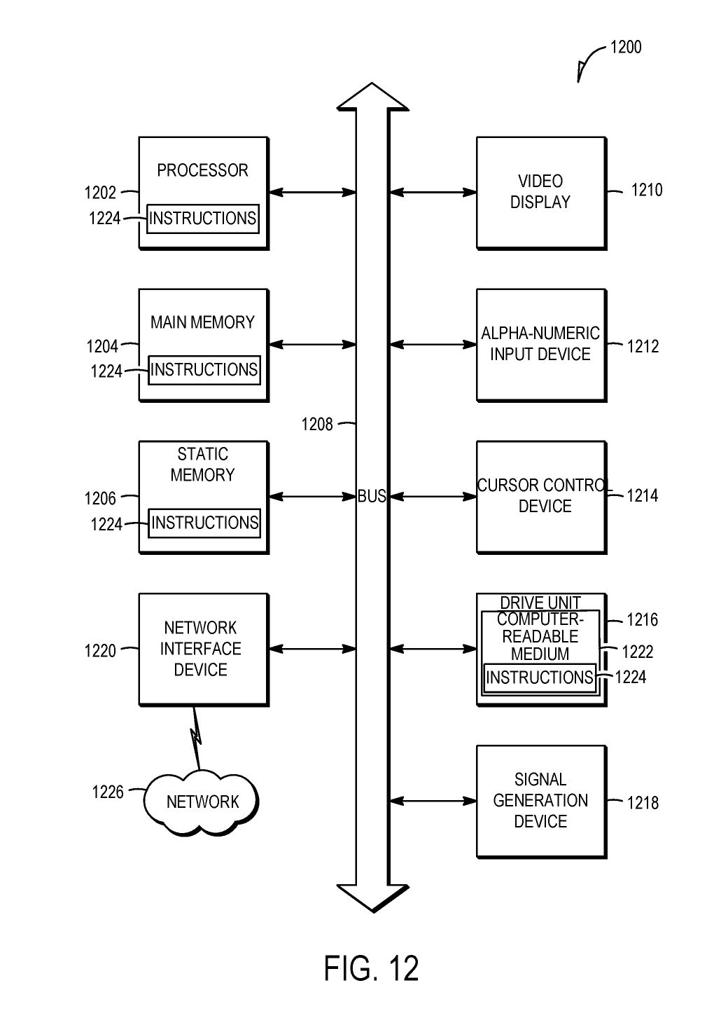

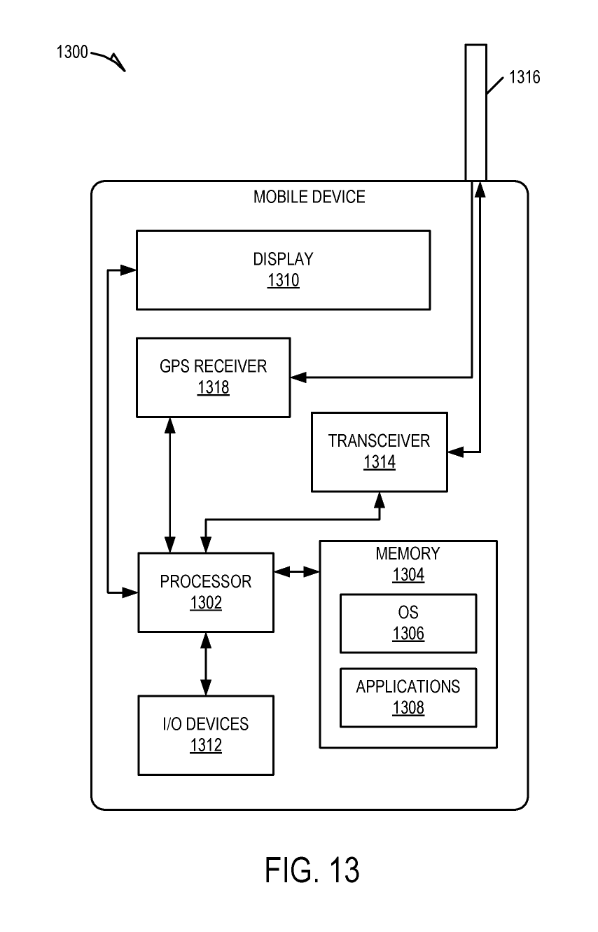

FIG. 1 is a block diagram illustrating an example of a network environment 100 suitable for classifying work processes, according to some example embodiments. The network environment 100 includes an AR device 101 and a server 110, communicatively coupled to each other via a network 108. The AR device 101 and the server 110 may each be implemented in a computer system, in whole or in part, as described below with respect to FIGS. 12 and 13. Machine A 116 and machine B 118 are capable of communicating with the server 110 via the network 108.

The server 110 may be part of a network-based system. For example, the network-based system may be or include a cloud-based server system that provides additional information, such as three-dimensional models or other virtual objects, to the AR device 101.

A user 102 uses the AR device 101 to detect several physical objects (e.g., machine A 116, machine B 118) in a real-world physical environment 114. The physical objects may include, for example, tools or components. For example, machine A 116 may be an engine connected to a fuel tank (e.g., machine B 118). Each machine 116, 118 includes sensors capable of measuring, for example, a geographical location, inertial position, orientation, temperature, pressure, and an operating status. The machines 116 and 118 can operate with one another or can operate independently from one another. The user 102 can connect or interact with both machines 116, 118 in the physical environment 114. For example, the user 102 turns on a switch on machine A 116 and connect machine A 116 to machine B 118. Other types of interactions include, for example, physically moving machine A 116 and machine B 118, and manipulating components (e.g., switches or buttons) on machine A 116 and machine B 118. Machine A 116 is also capable of interacting with machine B 118. For example, machine A 116 includes a device (e.g., a part of an assembly machine) that can communicate or interact with another device (e.g., another part of the assembly machine—machine B 118).

The user 102 may be a human user (e.g., a human being), a machine user (e.g., a computer configured by a software program to interact with the AR device 101), or any suitable combination thereof (e.g., a human assisted by a machine or a machine supervised by a human). The user 102 is not part of the network environment 100, but is associated with the AR device 101 and may be a user 102 of the AR device 101. For example, the AR device 101 may be a computing device with a (transparent or non-transparent) display such as a smartphone, a tablet computer, a wearable computing device (e.g., glasses), or a head-mounted computing device (e.g., helmet, visor). The computing device may be handheld or may be removably mounted to the head of the user 102. In one example, the display may be a screen that displays an image captured with an optical sensor (e.g., camera) of the AR device 101.

The AR device 101 includes an AR application that provides the user 102 with an augmented experience (e.g., virtual objects appearing in a line of sight of the user 102) triggered by identified objects in the physical environment 114. The physical environment 114 may include identifiable objects (e.g., machines 116, 118) such as a two-dimensional physical object (e.g., a picture), a three-dimensional physical object (e.g., a factory machine), a location (e.g., at the bottom floor of a factory), or any references (e.g., perceived corners of walls or furniture) in the physical environment 114. For example, the user 102 may point a camera of the AR device 101 to capture an image of the machines 116, 118.

In one embodiment, the objects in the image are tracked and recognized locally in the AR device 101 using a dataset (also referred to as a local context recognition dataset) or any other previously stored dataset of the AR application of the AR device 101. The local context recognition dataset may include a library of virtual objects associated with real-world physical objects or references. In one example, the AR device 101 identifies feature points in an image of the machines 116, 118 to determine different planes (e.g., edges, corners, surface). The AR device 101 also identifies tracking data related to the machines 116, 118 (e.g., machine A 116 is located two feet to the left of the user 102, machine B 118 is located four feet in front of the user 102). If the captured image is not recognized locally at the AR device 101, the AR device 101 downloads additional information (e.g., the three-dimensional model) corresponding to the captured image, from a database of the server 110 over the network 108.

In another embodiment, the machines 116, 118 in the image are tracked and recognized remotely at the server 110 using a remote context recognition dataset or any other previously stored dataset of an AR application in the server 110. The remote context recognition dataset may include a library of virtual objects associated with real-world physical objects or references.

External sensors 112 may be associated with, coupled to, or related to the machines 116, 118 in the physical environment 114 to measure data related to the machines 116, 118. Examples of measured data include but are not limited to operational status, status of components, weight, pressure, temperature, velocity, direction, position, intrinsic and extrinsic properties, and dimensions.

For example, the external sensors 112 may be disposed inside the machine A 116 (e.g., a factory machine such as a robotic machine) to measure movement, pressure, orientation, temperature, etc. The server 110 can compute physical characteristics of the machine A 116 using the live data generated by the external sensors 112. For example, the server 110 can detect the amount of heat generated by the machine A 116 as it is being used and operated by the user 102. The server 110 can use the sensor data from the external sensors 112 to determine and classify a task (e.g., testing or cleaning an engine) being performed by the user 102. The server 110 can then generate virtual indicators such as vectors or colors based on the task of the user 102. The virtual indicators can be used to assist the user 102 based on a level of difficulty of performing the task. For example, the number of virtual indicators may be adjusted based on the level of difficulty of performing the task, and on the sensor data. For example, if the engine overheats while the user 102 is fixing the engine, the AR device 101 display virtual arrows and prompts to remedy or correct the task of repairing the engine. The virtual arrows are displayed in the display of the AR device 101. In another example embodiment, the virtual indicators are rendered at the server 110 and streamed to the AR device 101. The AR device 101 displays the virtual indicators or visualization corresponding to a display of the physical environment 114.

The external sensors 112 can also include other sensors used to track the location, movement, and orientation of the AR device 101 externally without having to rely on the sensors internal to the AR device 101. The external sensors 112 may include optical sensors (e.g., depth-enabled 3D camera), wireless sensors (e.g., Bluetooth, Wi-Fi), GPS sensors, and audio sensors to determine the location of the user 102 having the AR device 101, the distance of the user 102 to the external sensors 112 in the physical environment 114 (e.g., sensors placed in corners of a venue or a room), and the orientation of the AR device 101 to track what the user 102 is looking at (e.g., direction at which the AR device 101 is pointed such as the AR device 101 being aimed at machine A 116).

In another embodiment, sensor data from the external sensors 112, sensors in the AR device 101, and sensors in the machines 116, 118 may be used for analytics data processing at the server 110 (or another server) for identifying a task of the user 102 and a level of difficulty of the task based on how the user 102 is interacting with the machines 116, 118 in the physical environment 114. Live data from other servers may also be used in the analytics data processing. For example, the analytics data may track at what locations (e.g., points or features) on the physical or virtual object the user 102 has looked, how long the user 102 has looked at each location on the physical or virtual object, how the user 102 held the AR device 101 when looking at the physical or virtual object, which features of the virtual object the user 102 interacted with (e.g., whether the user 102 tapped on a link in the virtual object), and any suitable combination thereof. The AR device 101 receives a visualization content dataset related to the analytics data. The AR device 101 then generates a virtual object with additional or visualization features, or a new experience, based on the visualization content dataset.

Any of the machines, databases, or devices shown in FIG. 1 may be implemented in a general-purpose computer modified (e.g., configured or programmed) by software to be a special-purpose computer to perform one or more of the functions described herein for that machine, database, or device. For example, a computer system able to implement any one or more of the methodologies described herein is discussed below with respect to FIGS. 12, 13. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 108 may be any network that enables communication between or among machines (e.g., server 110), databases, and devices (e.g., AR device 101). Accordingly, the network 108 may be a wired network, a wireless network (e.g., a mobile or cellular network), or any suitable combination thereof. The network 108 may include one or more portions that constitute a private network, a public network (e.g., the Internet), or any suitable combination thereof.

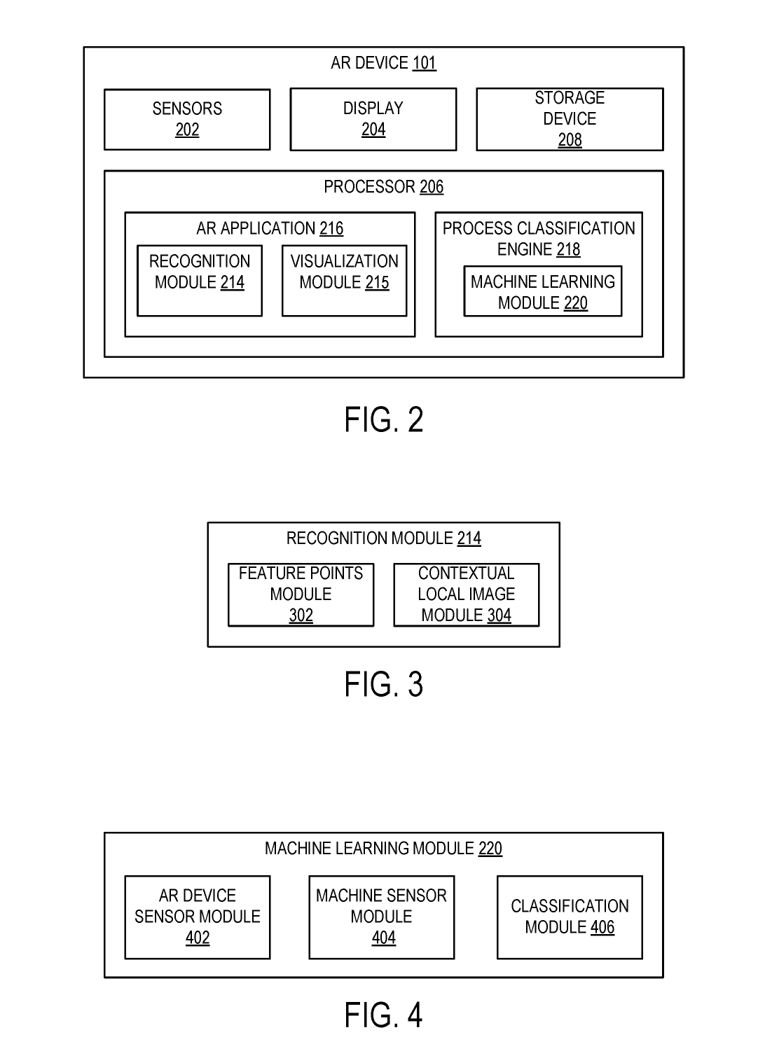

FIG. 2 is a block diagram illustrating modules (e.g., components) of the AR device 101, according to some example embodiments. The AR device 101 includes sensors 202, a display 204, a processor 206, and a storage device 208. For example, the AR device 101 may be a wearable computing device (e.g., glasses or helmet), a desktop computer, a vehicle computer, a tablet computer, a navigational device, a portable media device, or a smart phone of a user.

The sensors 202 include, for example, a proximity or location sensor (e.g., Near Field Communication (NFC), GPS, Bluetooth, Wi-Fi), an optical sensor (e.g., infrared camera, human-visible spectrum camera, depth sensor), an orientation sensor (e.g., gyroscope, inertial measuring unit), an audio sensor (e.g., a microphone), a biometric sensor (e.g., EEG, temperature, heart monitor), or any suitable combination thereof. The sensors 202 are used to generate internal tracking data of the AR device 101 to determine a state of the AR device 101 and an identification of physical objects in the real physical world.

The display 204 includes, for example, a touchscreen display configured to receive a user input via a contact on the touchscreen display. In one example, the display 204 may include a screen or monitor configured to display images generated by the processor 206. In another example, the display 204 may be transparent so that the user 102 can see through the display 204 (e.g., head-up display).

The processor 206 includes an AR application 216 and a process classification engine 218. The process classification engine 218 receives sensor data from the sensors 202, sensor data from the machines 116, 118, and sensor data from the external sensors 112 to classify a task or process (e.g., cleaning an engine, fixing a valve) based on the interactions between the user 102 and the machines 116, 118. A machine learning module 220 correlates sensor data to tasks based on historical sensor data. For example, if a switch A of the machine A 116 is turned off and a panel cover of the machine A 116 is opened, the task is associated with replacing a particular component (e.g., filter) of the machine A 116. The process classification engine 218 uses the sensor data (and previous sensor data from previous interactions) to further determine patterns associated with different tasks. Based on the patterns and the present sensor data, the process classification engine 218 determines the task being performed by the user 102 and the level of difficulty. For example, difficult tasks may be determined based on a higher number of interactions between the user 102 and the machines 116, 118 to accomplish the task successfully. The success of the task may be determined and measured using the sensor data (e.g., a sensor in the machine A 116 senses a new filter). Other factors in determining the level of difficulty include specifications of the machines 116, 118, a level of expertise of the user 102, type of tasks being performed, and level of focus of the user 102.

The AR application 216 generates and displays AR content based on the task of the user 102 and a level of difficulty of the task. In one example embodiment, the AR application 216 may include a recognition module 214 and a visualization module 215. The recognition module 214 detects and identifies physical objects (e.g., machines 116, 118) in the physical environment 114.

The visualization module 215 causes the display 204 to display the AR content. The AR content may include a three-dimensional object (e.g., model of a screwdriver) or a two-dimensional object (e.g., arrow or symbols) displaying parts of the scene or objects in different colors. In one example embodiment, the visualization module 215 receives AR content from the server 110 to generate and render the visualization. In another example embodiment, the visualization module 215 receives the rendered object. The visualization module 215 further determines the position and size of the rendered object to be displayed in relation to an image of the object. For example, the visualization module 215 places the virtual screwdriver with the size and position based on the image of the object, such that the virtual screwdriver is displayed at the appropriate location on the machine A 116 with the appropriate size. The visualization module 215 may track the image of the object and render the virtual object based on the position of the image of the object in a display of the AR device 101. In another example, the visualization module 215 may render portions of the objects or the scene in different colors based on the AR content.

In one example embodiment, the AR device 101 accesses from a local memory a visualization model (e.g., vector shapes) corresponding to the image of the object (e.g., machine A 116). In another example, the AR device 101 receives a visualization model corresponding to the image of the object from the server 110. The AR device 101 then renders the visualization model to be displayed in relation to an image of the object being displayed in the AR device 101 or in relation to a position and orientation of the AR device 101 relative to the object. The AR application 216 adjusts a position of the rendered visualization model in the display 204 to correspond with the last tracked position of the object (as last detected either from the sensors 202 of the AR device 101 or from the external sensors 112).

The visualization module 215 may include a local rendering engine that generates a visualization of a three-dimensional virtual object overlaid on (e.g., superimposed upon, or otherwise displayed in tandem with) an image of a physical object captured by a camera of the AR device 101 in the display 204 of the AR device 101. The visualization of the three-dimensional virtual object may be manipulated by adjusting a position of the physical object (e.g., its physical location, orientation, or both) relative to the camera of the AR device 101. Similarly, the visualization of the three-dimensional virtual object may be manipulated by adjusting a position of the camera of the AR device 101 relative to the physical object.

In one example embodiment, the visualization module 215 may retrieve three-dimensional models of virtual objects associated with a captured real-world object. For example, the captured image may include a visual reference (also referred to as a marker) that consists of an identifiable image, symbol, letter, number, or machine-readable code. For example, the visual reference may include a bar code, a quick response (QR) code, or an image that has been previously associated with a three-dimensional virtual object (e.g., an image that has been previously determined to correspond to the three-dimensional virtual object).

In one example embodiment, the visualization module 215 may include a manipulation module that identifies the physical object (e.g., a physical telephone), accesses virtual functions (e.g., increase or lower the volume of a nearby television) associated with physical manipulations (e.g., lifting a physical telephone handset) of the physical object, and generates a virtual function corresponding to a physical manipulation of the physical object.

FIG. 3 is a block diagram illustrating an example embodiment of modules of a recognition module 214. The recognition module 214 includes, for example, a feature points module 302 and a contextual local image module 304. The feature points module 302 detects, generates, and identifies identifiers such as feature points (e.g., unique interface layout, unique geometric shape or pattern) of the machines 116, 118 using an optical device of the AR device 101 to capture images of the machines 116, 118. The identification of the object may be performed in many different ways. For example, the feature points module 302 may determine feature points of the object based on several image frames of the object. The feature points module 302 may also determine the identity of the object using any visual recognition algorithm.

In another example, a unique identifier may be associated with the object. The unique identifier may be a unique wireless signal or a unique visual pattern such that the recognition module 214 can look up the identity of the object Attorney Docket No. 3621.099US1 12 based on the unique identifier from a local or remote content database. In another example embodiment, the recognition module 214 includes machine vision techniques to identify physical objects.

The contextual local image module 304 determines whether the captured image matches an image locally stored in a local database of images and corresponding additional AR content (e.g., three-dimensional model and interactive features generated by the process classification engine 218) on the AR device 101. In one example embodiment, the contextual local image module 304 retrieves a primary content dataset (e.g., “standard” or most common AR content associated with the machine A 116) from the server 110, and generates and updates a contextual content dataset based an image captured with the AR device 101.

FIG. 4 is a block diagram illustrating an example embodiment of modules of a machine learning module 220. The machine learning module 220 includes, for example, an AR device sensor module 402, a machine sensor module 404, and a classification module 406. The AR device sensor module 402 communicates with the sensors 202 to receive sensor data related a status of the AR device 101 (e.g., physical objects identified, information related to physical objects identified such as spatial relationship between the physical objects—machine A 116 is put on top of machine B 118). The machine sensor module 404 receives sensor data from sensors in the machines 116, 118 related to information and status of the machines 116, 118 (e.g., machine A 116 is an engine model X and is operational, machine B 118 is a cleaning tool positioned on top of the engine). The classification module 406 determines and identifies a task of the user 102 based on the interaction of the user 102, machine A 116, and machine B 118. User interaction includes physical movement of the machines 116, 118 or looking at specific parts of the machines 116, 118. The task may be determined, for example, based on the type of machine, the time at which the machine is being operated, the location of the machine, which machine the user 102 is interacting with, the interaction between the machines 116, 118, which components are being manipulated, the order in which components are being manipulated or moved or looked at, the pattern of manipulation of components of the machines, a technical expertise of the user 102 (e.g., repairman), task results from similar manipulation patterns (e.g., flipping switch B and turning valve A should result in a specific gas pressure range in a pipe of machine A 116), and historical task results with corresponding interaction patterns. In another example embodiment, the classification module 406 determines a level of difficulty of the task based on biometric data from the AR device 101. For example, a higher level of concentration or focus as determined using the biometric data may indicate that the task being performed by the user 102 requires a lot of attention. The process classification engine 218 generates or accesses AR content associated with the identified task and the level of difficulty of the identified task. For example, AR content includes more instructions and clues for tasks with higher difficulties.

Referring back to FIG. 2, the storage device 208 stores a database of identifiers of physical objects, sensor data, tasks, task levels of difficulty, and corresponding AR content. In another example embodiment, the database includes visual references (e.g., images) and corresponding AR content (e.g., three-dimensional virtual objects, interactive features of the three-dimensional virtual objects showing steps in performing an identified task). For example, the visual reference may include a machine-readable code or a previously identified image (e.g., image of machine A 116). The previously identified image of the machine A 116 corresponds to a three-dimensional virtual model of the machine A 116 that can be viewed from different angles by manipulating the position of the AR device 101 relative to the machine A 116. Features of the three-dimensional virtual model of the machine A 116 may include selectable icons on the three-dimensional virtual model of the machine A 116. An icon may be selected or activated by tapping on or moving the AR device 101.

In one embodiment, the storage device 208 includes a primary content dataset, a contextual content dataset, and a visualization content dataset. The primary content dataset includes, for example, a first set of images and corresponding experiences (e.g., interactions with three-dimensional virtual object models). For example, an image may be associated with one or more virtual object models. The primary content dataset may include a core set of images or the most popular images determined by the server 110. The core set of images may include a limited number of images identified by the server 110. For example, the core set of images may include the images depicting covers of the ten most common tasks for a machine and their corresponding experiences (e.g., virtual objects showing how to perform those tasks). In another example, the server 110 may generate the first set of images based on the most common tasks identified at the server 110. Thus, the primary content dataset does not depend on objects or images scanned by the recognition module 214 of the AR device 101.

The contextual content dataset includes, for example, a second set of images and corresponding experiences (e.g., interactions with three-dimensional virtual object models) retrieved from the server 110. For example, images captured with the AR device 101 that are not recognized (e.g., by the server 110) in the primary content dataset are submitted to the server 110 for recognition. If the captured image is recognized by the server 110, a corresponding experience may be downloaded at the AR device 101 and stored in the contextual content dataset. Thus, the contextual content dataset relies on the context in which the AR device 101 has been used. As such, the contextual content dataset depends on objects or images scanned by the recognition module 214 of the AR device 101.

In one embodiment, the AR device 101 may communicate over the network 108 with the server 110 to retrieve a portion of a database of visual references, corresponding three-dimensional virtual objects, and corresponding interactive features of the three-dimensional virtual objects.

Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

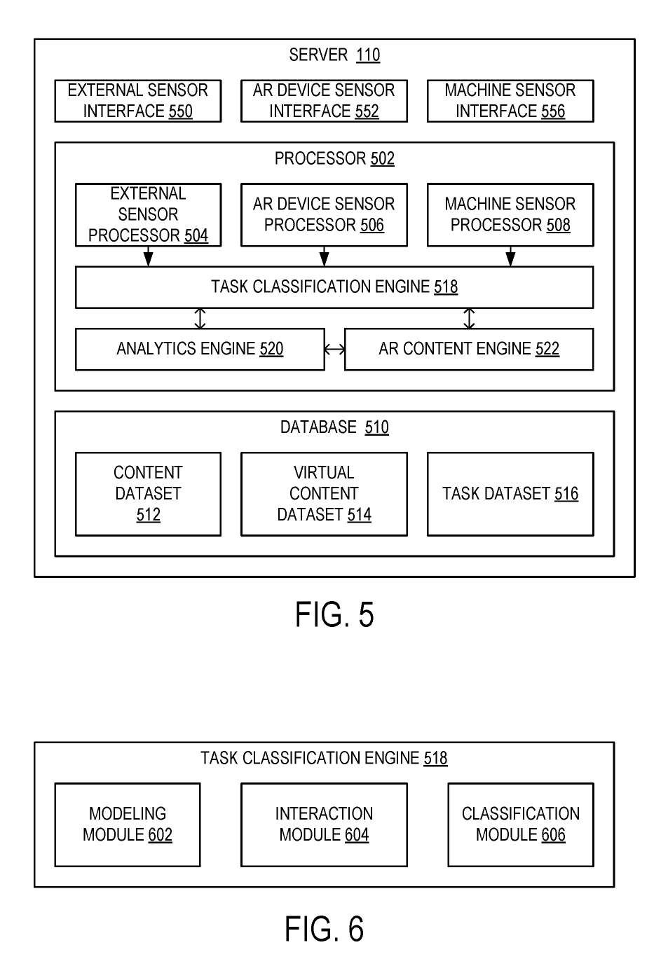

FIG. 5 is a block diagram illustrating modules (e.g., components) of the server 110. The server 110 includes an external sensor interface 550, an AR device sensor interface 552, a machine sensor interface 556, a processor 502, and a database 510. The external sensor interface 550 communicates with the external sensors 112 (FIG. 1) to receive real-time sensor data. The AR device sensor interface 552 communicates with the AR device 101 (FIG. 1) to receive sensor data generated by the sensors 202 of the AR device 101. The machine sensor interface 556 communicates with the machines 116, 118 (FIG. 1) to receive sensor data generated by the sensors in the machines 116, 118.

The processor 502 includes an external sensor processor 504, an AR device sensor processor 506, a machine sensor processor 508, a task classification engine 518, an analytics engine 520, and an AR content engine 522.

The external sensor processor 504 receives sensor data from the external sensor interface 550. The sensor data include, for example, location data of the machines 116, 118 and the AR device 101; orientation of the machines 116, 118 and the AR device 101; identification information related the machines 116, 118, the AR device 101, and the user 102; and pictures and video of the machines 116, 118 and the AR device 101. The external sensor processor 504 also uses the sensor data to identify the physical objects (e.g., machines 116, 118) detected by the AR device 101. For example, the external sensor processor 504 can determine the task of the user 102 based on the identification of the physical objects, the combination of the identified physical objects, their respective location and motion, and a pattern of manipulation of the physical objects (e.g., user 102 moves machine A 116 on top of machine B 118, user 102 then turns off machine B 118, user 102 then switches on machine A 116 and rotates machine B 118 90 degrees relative to machine A 116). Specific combinations of physical objects, corresponding motions, and corresponding positions, as detected by the external sensors 112, are associated with specific tasks or activities. Patterns of motions can also be associated with specific tasks.

The AR device sensor processor 506 receives sensor data from the AR device sensor interface 552. The sensor data include, for example, geographic location data, image data captured by the AR device 101, optical data from optical sensors (e.g., infrared camera, human-visible spectrum camera, depth sensor), orientation data (e.g., from gyroscope or inertial measuring unit), audio data from audio sensors (e.g., a microphone), biometric data (e.g., EEG, temperature, heart monitor), and identification data related to the user 102. The AR device sensor processor 506 uses the sensor data to determine a task (e.g., cleaning a filter of an engine) of the user 102 or a type of activity (“work”) being performed by the user 102. The AR device sensor processor 506 also uses the sensor data to identify the physical objects (e.g., machines 116, 118) detected by the AR device 101. For example, the AR device sensor processor 506 can determine the task based on the identification of the physical objects, the combination of the specific physical objects (e.g., a hammer and a screwdriver), their respective motion (e.g., screwdriver moved from a storage area to another location), and their respective position (e.g., screwdriver on the left side of machine). Similarly, specific combinations of physical objects, corresponding motions, and corresponding positions, as detected by the AR device 101, are associated with specific tasks or activities. Patterns of motions can also be associated with specific tasks. The AR device sensor processor 506 can also use the sensor data to determine a level of difficulty of the task based on the time to perform a pattern of motion (e.g., longer steps require more time) and a level of concentration or focus of the user 102 based on biometric data of the user 102.

The machine sensor processor 508 receives sensor data from the machine sensor interface 556. The sensor data include, for example, location data, image data captured by the machine sensor, temperature data, pressure data, switch/valve position data, operational data, audio data, and identification data (e.g., manufacturer, normal operating temperatures) related to the machines 116, 118. The machine sensor processor determines a task based on the sensor data from the machines 116, 118. For example, the task may be “task A” if sensor data from sensors X, Y, Z are within respective ranges x1-x2, y1-y2, and z1-z2. Specific combinations of sensor data from each sensor are associated with specific tasks or activities (e.g., machine A 116 is being repaired). Patterns of sensor data (e.g., switch A is turned off, valve B is closed after switch A is off, and panel C is opened after valve B is closed) can also be associated with specific tasks.

The task classification engine 518 determines and classifies a task or an activity of the user 102 based on the sensor data from the external sensors 112, sensor data from the AR device 101, and sensor data from the machines 116, 118. The task classification engine 518 determines and classifies a task or an activity of the user 102 based on comparison with a pattern of the sensor data correlated to a specific task. For example, the external sensor processor 504, AR device sensor processor 506, and machine sensor processor 508 identify the user 102 and the machines 116, 118 and a set of actions performed by the user 102 on the machines 116, 118. The task classification engine 518 determines the task based on the set of actions, the identity of the user 102, and the status of the machines 116, 118. In another example embodiment, the task classification engine 518 identifies and classifies the task of the user 102 based on the tasks identified by the external sensor processor 504, the AR device sensor processor 506, and the machine sensor processor 508.

The analytics engine 520 performs analytics based on the task identified by the task classification engine 518. Examples of analytics performed include measuring a performance of the user 102 based on historical sensor data for similar tasks (e.g., cleaning an engine of similar size or model). In another example embodiment, the analytics engine 520 determines a level of difficulty of the task based on biometric data from the AR device 101. For example, a higher level of concentration or focus as determined using the biometric data may indicate that the task being performed by the user 102 requires a lot of attention.

The AR content engine 522 generates AR content based on the identified task and the level of difficulty of the identified task. For example, the AR content includes more instructions and clues for tasks with higher difficulties than for tasks with lower difficulties.

The database 510 may store a content dataset 512, a virtual content dataset 514, and a task dataset 516. The content dataset 512 may store a primary content dataset and a contextual content dataset. The primary content dataset comprises a first set of images and corresponding virtual object models. The AR device sensor processor 506 determines that a captured image received from the AR device 101 is not recognized in the primary content dataset, and generates the contextual content dataset for the AR device 101. The contextual content dataset may include a second set of images and corresponding virtual object models. The virtual content dataset 514 includes models of virtual objects to be generated upon receiving a notification associated with an image of a corresponding physical object. The task dataset 516 includes data related to physical objects (e.g., model and specifications of the machines 116, 118), tasks and corresponding sensor data, tasks and corresponding combinations of physical objects detected by the AR device 101, tasks and corresponding patterns of sensor data, tasks and corresponding levels of difficulty, and tasks and corresponding outcome sensor data.

FIG. 6 is a block diagram illustrating an example embodiment of modules of a task classification engine 518. The task classification engine 518 includes a modeling module 602, an interaction module 604, and a classification module 606. The modeling module 602 includes a model of sensor data, sensor data patterns, and corresponding tasks. For example, a task of fixing machine A 116 is consistent with (associated with) sensor data indicating that machine A 116 is malfunctioning, that the user 102 is authorized to fix machine A 116, that the user 102 has proper tools commonly used to fix machine A 116, that the user 102 has shut off a valve connected to machine A 116, and that a panel of machine A 116 is open after the valve is turned off. The modeling module 602 may be based on historical sensor data (e.g., from a combination of the external sensors 112, AR device 101, and sensors inside the machines 116, 118) and corresponding tasks previously identified with the historical sensor data. The modeling module 602 further determines a task outcome based on the historical sensor data. For example, patterns of actions from the user 102 along with sensor data xyz result in a positive outcome in which the machine is fixed. In another example embodiment, the modeling module 602 identifies a level of difficulty of a task based on biometric data from the user 102 and other parameters such as the number of steps or actions taken to finalize the task (e.g., finish repairing the engine). The level of difficulty may also be based on the level of expertise of the user 102.

The interaction module 604 identifies the interactions between the user 102 and the physical objects (e.g., machines 116 and 118). For example, the interaction module 604 identifies that the user 102 shut off a valve between machine A 116 and machine B 118. The interaction module 604 determines that machine A 116 produces less energy than machine B 118 as a result of the action of the user 102. A combination of machine vision and sensor data from the machines 116, 118 can be used to determine and identify the interactions.

The classification module 606 identifies the task based on a comparison of the interactions as determined by the interaction module 604 with the pattern of actions model from the modeling module 602. For example, the classification module 606 determines that the task of the user 102 is to diagnose machine A 116 based on specific actions taken by the user 102 and detected by the external sensors 112, the AR device 101, and the machines 116, 118.

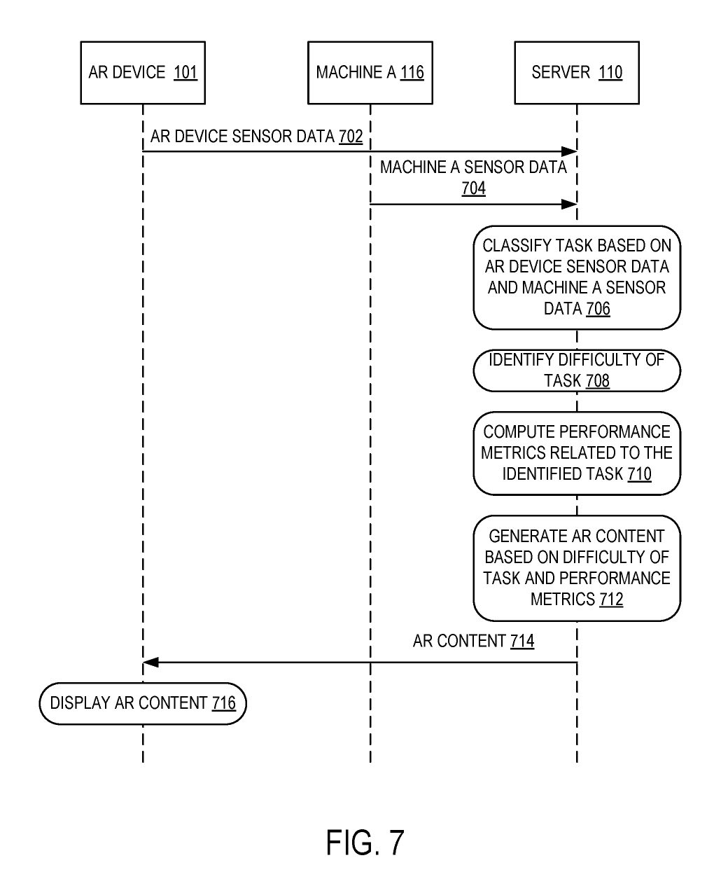

FIG. 7 is a ladder diagram illustrating an example embodiment of an operation of work process classification. At operation 702, the AR device 101 sends its sensor data to the server 110. In one example embodiment, the AR device sensor module 402 (FIG. 4) sends sensor data to the AR device sensor interface 552 (FIG. 5) of the server 110. At operation 704, the machine A 116 sends its sensor data to the server 110. In one example embodiment, sensors in the machine A 116 send data to the machine sensor interface 556 (FIG. 5) of the server 110.

At operation 706, the server 110 identifies and classifies a task based on the sensor data from the AR device 101 and the machine A 116. In one example embodiment, operation 706 is implemented with the task classification engine 518 (FIG. 5) of the server 110.

In another example embodiment, the task classification engine 518 may identify a task irrespective of the task's complexity. For example, the task classification engine 518 can use various inputs, including AR device sensor data, external sensor data, any available task information, user information, etc. and determine which category/bucket a task falls into. These categories/buckets can be arbitrary, depending on the use case, so the machine learning system would need to use some sort of training set to train the classification module 406. Some example task classifications include “Mechanical Installation Task”, “Safety Task”, “Rotational Mechanical Installation Task”, “Linear Mechanical Installation Task”, etc. These task classifications could also be more abstract, such as, “Mental Acuity Heavy Task”, “Mental Flexibility Heavy Task”, etc. Generally, these tasks may be defined by any number of arbitrary independent variables, such as physical movement, machine data, task parameters.

In another example embodiment, task complexity ranks a particular task within these categories. Typically, task complexity is more associated with an arbitrary dependent variable, such as time taken to perform the task, or data output.

For example, an AR-based wearable device would massively widen the data set (e.g., increase the number of independent inputs) by providing a large number of new sensors and a task management system. All of this new sensor input and task information would be used to classify the type of task a device-wearer is working on, and potentially the difficulty level, which could then be used as input for training needs, task management, etc.

At operation 708, the server 110 identifies a level of difficulty of the task. In one example embodiment, operation 708 is implemented with the analytics engine 520 (FIG. 5).

At operation 710, the server 110 computes performance metrics related to the identified task. In one example embodiment, operation 710 is implemented with the analytics engine 520 (FIG. 5). For example, the analytics engine 520 may compute a performance metric based on the time taken by the user to accomplish the identified task. Further, the time taken by the user to accomplish the identified task may be compared to historical data on the time taken by other users to complete the identified task within the same or different context or under the same or different conditions.

At operation 712, the server 110 generates AR content based on the difficulty of the task (e.g., task corresponds to difficulty level 3) and the performance metrics (e.g., user 102 is performing too slow or incorrectly for the task). For example, the AR content provides more guidance when the task is more difficult or when the user 102 is having difficulty in performing the task. In one example embodiment, operation 712 is implemented with the AR content engine 522 (FIG. 5). At operation 714, the server 110 communicates the AR content generated at operation 712 to the AR device 101. At operation 716, the AR device 101 displays the AR content received from the server 110.

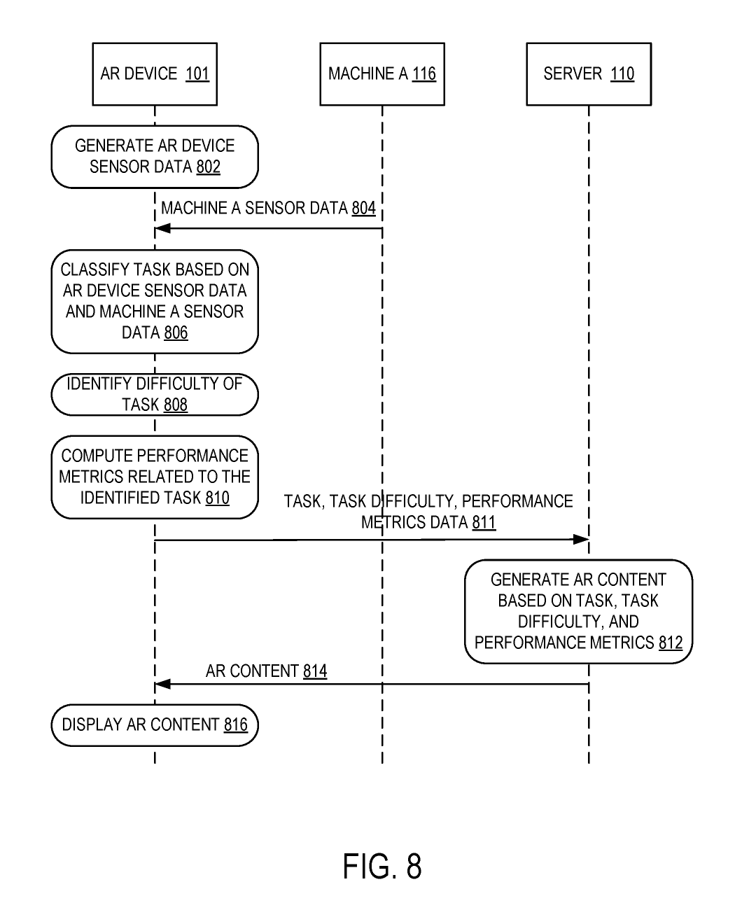

FIG. 8 is a ladder diagram illustrating another example embodiment of an operation of work process classification. At operation 802, the AR device 101 generates sensor data using the sensors 202. In one example embodiment, the AR device sensor module 402 (FIG. 4) receives the sensor data from the users 102 of the AR device 101. At operation 804, the AR device 101 receives sensor data from machine A 116. In one example embodiment, sensors in the machine A 116 send sensor data to the machine sensor module 404 (FIG. 4) of the AR device 101.

At operation 806, the AR device 101 identifies and classifies a task based on the sensor data from the AR device 101 and from the machine A 116. In one example embodiment, operation 806 is implemented with the classification module 406 (FIG. 4) of the AR device 101.

At operation 808, the AR device 101 identifies a level of difficulty of the task. In one example embodiment, operation 808 is implemented with the classification module 406 (FIG. 4) of the AR device 101.

At operation 810, the AR device 101 computes performance metrics related to the identified task. In one example embodiment, operation 810 is implemented with the classification module 406 (FIG. 4) of the AR device 101. At operation 811, the AR device 101 sends data related to the task, task difficulty, and performance metrics to the server 110. The server 110 generates AR content based on the task, task difficulty, and performance metrics at operation 812. The server 110 communicates the AR content to the AR device 101 at operation 814. The AR device 101 displays the AR content at operation 816.

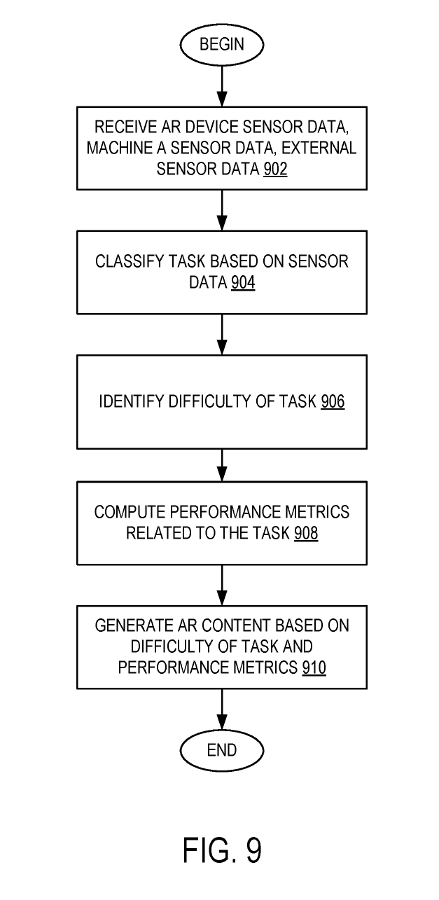

FIG. 9 is a flowchart illustrating an example operation of generating AR content based on a work process classification. At operation 902, a server receives AR device sensor data from an AR device, machine sensor data from a machine detected (e.g., by wireless detection such as RFID, or optical detection such as the machine being within a field of view of an optical device of the AR device) by the AR device, and external sensor data from external sensors. At operation 904, the server classifies a task based on the aggregate sensor data. At operation 906, the server identifies a difficulty of the task based on the aggregate sensor data. At operation 908, the server computes performance metrics related to the task based on the aggregate sensor data. At operation 910, the server generates AR content based on the difficulty of the task and performance metrics of the user.

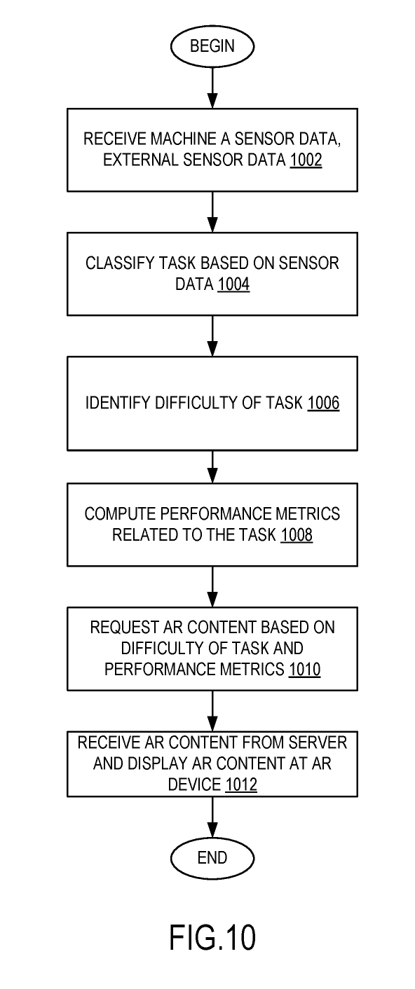

FIG. 10 is a flowchart illustrating another example operation of generating AR content based on a work process classification. At operation 1002, an AR device receives machine sensor data from a machine detected (e.g., by wireless detection such as RFID, or optical detection such as the machine being within a field of view of an optical device of the AR device) by the AR device, and external sensor data from external sensors. At operation 1004, the AR device classifies a task based on the aggregate sensor data (e.g., machine sensor data, external sensor data, AR device sensor data). At operation 1006, the AR device identifies a difficulty of the task based on the aggregate sensor data. At operation 1008, the AR device computes performance metrics related to the task based on the aggregate sensor data. At operation 1010, the AR device provides the aggregate sensor data and requests AR content from a server based on the aggregate sensor data. At operation 1012, the AR device receives AR content from the server and displays the AR content in a display of the AR device.

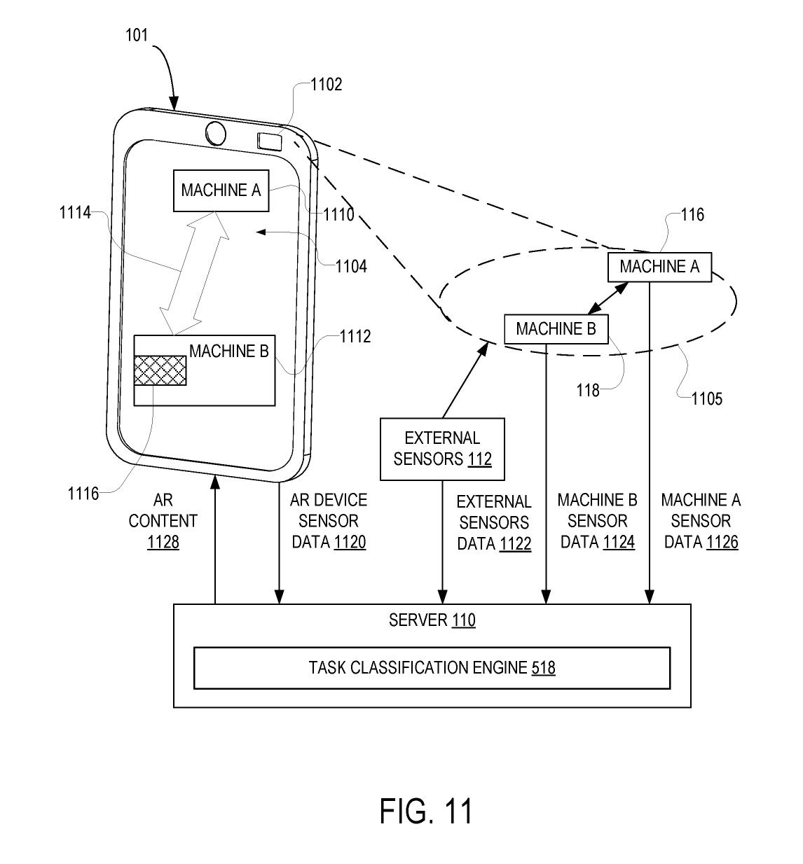

FIG. 11 is a diagram illustrating an example operation of classifying a work process and generating AR content based on the classification of the work process. The AR device 101 includes a handheld mobile device having a rear view camera 1102 and a touch sensitive display 1104. The rear view camera 1102 may have a field of view 1105 that includes machine A 116 and machine B 118. The rear view camera 1102 captures an image of both machines 116, 118 and displays corresponding images 1110, 1112 of the machines 116, 118 in the display 1104. The AR device 101 generates AR device sensor data 1120 related to the AR device 101 and communicates the AR device sensor data 1120 to the server 110. The external sensors 112 generate external sensors data 1122 that are communicated to the server 110. Machine A 116 generates machine A sensor data 1126 that are communicated to the server 110. Machine B 118 generates machine B sensor data 1124 that are communicated to the server 110. The task classification engine 518 of the server 110 determines a task and a difficulty of the task based on the sensor data. For example, the task classification engine 518 determines interactions of machine A 116 with machine B 118 as illustrated by the arrow 1114 between machine A 116 and machine B 118 in FIG. 11 based on the sensor data. The task and difficulty of the task can also be determined based on the interactions between the user of the AR device 101 and the machines 116, 118. The server 110 generates AR content 1128 based on the identified task and the level of difficulty of the task. In other examples, the AR content 1128 is also based on performance metrics of the user of the AR device 101. For example, the AR content 1128 provides less information/tips for an expert user as determined by the performance metrics. The server 110 communications the AR content 1128 to the AR device 101. For example, the AR content 1128 includes a virtual area 1116 overlaid on a corresponding part of the image 1112 of the machine B 1108 to show the user of the AR device 101 where to connect the machine A 1106 to the machine B 1108 based on the identified task.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network and via one or more appropriate interfaces (e.g., application programming interfaces (APIs)).

### Electronic Apparatus and System

Example embodiments may be implemented in digital electronic circuitry, in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., an FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Example Machine Architecture and Machine-Readable Medium

FIG. 12 is a block diagram of a machine in the example form of a computer system 1200 within which instructions 1224 for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU), or both), a main memory 1204, and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard), a user interface (UI) navigation (or cursor control) device 1214 (e.g., a mouse), a disk drive unit 1216, a signal generation device 1218 (e.g., a speaker), and a network interface device 1220.

### Machine-Readable Medium

The disk drive unit 1216 includes a computer-readable medium 1222 on which is stored one or more sets of data structures and instructions 1224 (e.g., software) embodying or utilized by any one or more of the methodologies or functions described herein. The instructions 1224 may also reside, completely or at least partially, within the main memory 1204 and/or within the processor 1202 during execution thereof by the computer system 1200, the main memory 1204 and the processor 1202 also constituting machine-readable media. The instructions 1224 may also reside, completely or at least partially, within the static memory 1206.

While the computer-readable medium 1222 is shown in an example embodiment to be a single medium, the term “computer-readable medium” may include a single medium or multiple media (e.g., a centralized or distributed database, and/or associated caches and servers) that store the one or more instructions 1224 or data structures. The term “computer -readable medium” shall also be taken to include any tangible medium that is capable of storing, encoding, or carrying instructions for execution by the machine and that cause the machine to perform any one or more of the methodologies of the present embodiments, or that is capable of storing, encoding, or carrying data structures utilized by or associated with such instructions. The term “computer-readable medium” shall accordingly be taken to include, but not be limited to, solid-state memories, and optical and magnetic media. Specific examples of computer-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 1224 may further be transmitted or received over a communications network 1226 using a transmission medium. The instructions 1224 may be transmitted using the network interface device 1220 and any one of a number of well-known transfer protocols (e.g., Hypertext Transfer Protocol (HTTP)). Examples of communication networks include a local area network (LAN), a wide area network (WAN), the Internet, mobile telephone networks, plain old telephone service (POTS) networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

### Example Mobile Device

FIG. 13 is a block diagram illustrating a mobile device 1300, according to an example embodiment. The mobile device 1300 may include a processor 1302. The processor 1302 may be any of a variety of different types of commercially available processors 1302 suitable for mobile devices 1300 (for example, an XScale architecture microprocessor, a microprocessor without interlocked pipeline stages (MIPS) architecture processor, or another type of processor 1302). A memory 1304, such as a random access memory (RAM), a flash memory, or another type of memory, is typically accessible to the processor 1302. The memory 1304 may be adapted to store an operating system (OS) 1306, as well as application programs 1308, such as a mobile location enabled application that may provide location-based services (LBSs) to a user. The processor 1302 may be coupled, either directly or via appropriate intermediary hardware, to a display 1310 and to one or more input/output (I/O) devices 1312, such as a keypad, a touch panel sensor, a microphone, and the like. Similarly, in some embodiments, the processor 1302 may be coupled to a transceiver 1314 that interfaces with an antenna 1316. The transceiver 1314 may be configured to both transmit and receive cellular network signals, wireless data signals, or other types of signals via the antenna 1316, depending on the nature of the mobile device 1300. Further, in some configurations, a GPS receiver 1318 may also make use of the antenna 1316 to receive GPS signals.

Although an embodiment has been described with reference to specific example embodiments, it will be evident that various modifications and changes may be made to these embodiments without departing from the scope of the present disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

The following enumerated embodiments describe various example embodiments of methods, machine-readable media, and systems (e.g., machines, devices, or other apparatus) discussed herein.

A first embodiment provides a server comprising:
one or more hardware processors comprising an AR application and a classification engine,
the classification engine configured to:
receive first sensor data from an AR device and second sensor data from a first machine detected by the AR device, the first and second sensor data related to a user of the AR device operating the first machine;
identify a task of the user based on the first and second sensor data;
identify a task result of the user of the AR device operating the first machine;
access task patterns and corresponding levels of difficulty related to the first machine; and
determine a difficulty of the task based on a comparison of the task, the task result, and the task patterns and corresponding levels of difficulty, and
the AR application configured to:
generate AR content based on the task and the difficulty of the task.

A second embodiment provides a server according to the first embodiment, wherein the classification engine is further configured to:
receive third sensor data from a sensor external to the AR device and to the first machine; and
identify the task and the task result based on the first, second, and third sensor data.

A third embodiment provides a server according to the first embodiment, wherein the first sensor data comprises a combination of at least user data, AR device data, and sensor data generated by sensors of the AR device.

A fourth embodiment provides a server according to the first embodiment, wherein the second sensor data comprises a combination of at least first machine specification data, first machine operational status data, and sensor data generated by sensors of the first machine.

A fifth embodiment provides a server according to the first embodiment, wherein the classification engine is further configured to:
receive third sensor data from a second machine;
determine a first interaction between the user of the AR device and the first machine, a second interaction between the user of the AR device and the second machine, and a third interaction between the first machine and the second machine based on the first, second, and third sensor data;
identify a second task of the user based on the first, second, and third interactions;
identify a second task result of the user of the AR device operating the first and second machines;
access task patterns and corresponding levels of difficulty related to the first and second machines; and
determine a difficulty of the second task based on a comparison of the second task, the second task result, and the task patterns and corresponding levels of difficulty related to the first and second machines.

A sixth embodiment provides a server according to the fifth embodiment, wherein the AR application is further configured to:
generate a first AR content based on the difficulty of the task and a second AR content based on the difficulty of the second task; and
communicate the first and second AR content to the AR device, the first and second AR content to be displayed in a transparent display of the AR device.

A seventh embodiment provides a server according to the first embodiment, wherein the classification engine is further configured to:
determine a skill level of the user based on the task of the user, the task result, and the difficulty of the task.

An eight embodiment provides a server according to the first embodiment, wherein the classification engine is further configured to:
receive a plurality of sensor data from a plurality of AR devices configured to detect the first machine;
determine the task patterns based on the plurality of sensor data and the second sensor data from the first machine;
determine the task result based on the plurality of sensor data and the second sensor data from the first machine; and
determine the level of difficulty for the first machine based on the task patterns and the task result.

A ninth embodiment provides a server according to the first embodiment, wherein the first sensor data includes biometric data indicative of a physical and mental state of the user of the AR device operating the first machine, and
wherein the classification engine is further configured to:
identify an attention level of the user of the AR device in performing the task based on the biometric data; and
classify the level of difficulty of the task based on the attention level.

A tenth embodiment provides a server according to the first embodiment, wherein the classification engine is further configured to:
identify an operation sequence of the user operating the first machine based on the first and second sensor data; and
determine a predicted task result based on a comparison of the operation sequence, the task patterns, and the corresponding levels of difficulty related to the first machine; and
wherein the AR application is further configured to:
generate a second AR content based on the predicted task result.

What is claimed is:

1. A server comprising:
one or more hardware processors comprising an AR application and a classification engine,
the classification engine configured to:
receive first sensor data from an AR device and second sensor data from a first machine detected by the AR device, the first and second sensor data related to a user of the AR device operating the first machine;
identify a task of the user based on the first and second sensor data;
identify a task result of the user of the AR device operating the first machine;
access task patterns and corresponding levels of difficulty related to the first machine; and
determine a difficulty of the task based on a comparison of the task, the task result, and the task patterns and corresponding levels of difficulty, and
the AR application configured to:
generate AR content based on the task and the difficulty of the task.

2. The server of claim 1, wherein the classification engine is further configured to:
receive third sensor data from a sensor external to the AR device and to the first machine; and
identify the task and the task result based on the first, second, and third sensor data.

3. The server of claim 1, wherein the first sensor data comprises a combination of at least user data, AR device data, and sensor data generated by sensors of the AR device.

4. The server of claim 1, wherein the second sensor data comprises a combination of at least first machine specification data, first machine operational status data, and sensor data generated by sensors of the first machine.

5. The server of claim 1, wherein the classification engine is further configured to:
receive third sensor data from a second machine;
determine a first interaction between the user of the AR device and the first machine, a second interaction between the user of the AR device and the second machine, and a third interaction between the first machine and the second machine based on the first, second, and third sensor data;
identify a second task of the user based on the first, second, and third interactions;
identify a second task result of the user of the AR device operating the first and second machines;
access task patterns and corresponding levels of difficulty related to the first and second machines; and
determine a difficulty of the second task based on a comparison of the second task, the second task result, and the task patterns and corresponding levels of difficulty related to the first and second machines.

6. The server of claim 5, wherein the AR application is further configured to:
generate a first AR content based on the difficulty of the task and a second AR content based on the difficulty of the second task; and
communicate the first and second AR content to the AR device, the first and second AR content to be displayed in a transparent display of the AR device.

7. The server of claim 1, wherein the classification engine is further configured to:
determine a skill level of the user based on the task of the user, the task result, and the difficulty of the task.

8. The server of claim 1, wherein the classification engine is further configured to:
receive a plurality of sensor data from a plurality of AR devices configured to detect the first machine;
determine the task patterns based on the plurality of sensor data and the second sensor data from the first machine;
determine the task result based on the plurality of sensor data and the second sensor data from the first machine; and
determine the level of difficulty for the first machine based on the task patterns and the task result.

9. The server of claim 1, wherein the first sensor data includes biometric data indicative of a physical and mental state of the user of the AR device operating the first machine, and
wherein the classification engine is further configured to:
identify an attention level of the user of the AR device in performing the task based on the biometric data; and
classify the level of difficulty of the task based on the attention level.

10. The server of claim 1, wherein the classification engine is further configured to:
identify an operation sequence of the user operating the first machine based on the first and second sensor data; and
determine a predicted task result based on a comparison of the operation sequence, the task patterns, and the corresponding levels of difficulty related to the first machine; and
wherein the AR application is further configured to:
generate a second AR content based on the predicted task result.

11. A method comprising:
receiving, at a server, first sensor data from an AR device and second sensor data from a first machine detected by the AR device, the first and second sensor data related to a user of the AR device operating the first machine;
identifying a task of the user based on the first and second sensor data;
identifying a task result of the user of the AR device operating the first machine;
accessing task patterns and corresponding levels of difficulty related to the first machine;
determining a difficulty of the task based on a comparison of the task, the task result, and the task patterns and corresponding levels of difficulty; and
generating AR content based on the task and the difficulty of the task.

12. The method of claim 11, further comprising:
receiving third sensor data from a sensor external to the AR device and to the first machine; and
identifying the task and the task result based on the first, second, and third sensor data.

13. The method of claim 11, wherein the first sensor data comprises a combination of at least user data, AR device data, and sensor data generated by sensors of the AR device.

14. The method of claim 11, wherein the second sensor data comprises a combination of at least first machine specification data, first machine operational status data, and sensor data generated by sensors of the first machine.

15. The method of claim 11, further comprising:
receiving third sensor data from a second machine;
determining a first interaction between the user of the AR device and the first machine, a second interaction between the user of the AR device and the second machine, and a third interaction between the first machine and the second machine based on the first, second, and third sensor data;
identifying a second task of the user based on the first, second, and third interactions;
identifying a second task result of the user of the AR device operating the first and second machines;
accessing task patterns and corresponding levels of difficulty related to the first and second machines; and
determining a difficulty of the second task based on a comparison of the second task, the second task result, and the task patterns and corresponding levels of difficulty related to the first and second machines.

16. The method of claim 15, further comprising:
generating a first AR content based on the difficulty of the task and a second AR content based on the difficulty of the second task; and
communicating the first and second AR content to the AR device, the first and second AR content to be displayed in a transparent display of the AR device.

17. The method of claim 11, further comprising:
determining a skill level of the user based on the task of the user, the task result, and the difficulty of the task.

18. The method of claim 11, further comprising:
receiving a plurality of sensor data from a plurality of AR devices configured to detect the first machine;
determining the task patterns based on the plurality of sensor data and the second sensor data from the first machine;
determining the task result based on the plurality of sensor data and the second sensor data from the first machine; and
determining the level of difficulty for the first machine based on the task patterns and the task result.

19. The method of claim 11, wherein the first sensor data includes biometric data indicative of a physical and mental state of the user of the AR device operating the first machine, and
wherein the method further comprises:
identifying an attention level of the user of the AR device in performing the task based on the biometric data; and
classifying the level of difficulty of the task based on the attention level.

20. A non-transitory machine-readable medium comprising instructions that, when executed by one or more processors of a machine, cause the machine to perform operations comprising:
receiving, at a server, first sensor data from an AR device and second sensor data from a first machine detected by the AR device, the first and second sensor data related to a user of the AR device operating the first machine;
identifying a task of the user based on the first and second sensor data;
identifying a task result of the user of the AR device operating the first machine;
accessing task patterns and corresponding levels of difficulty related to the first machine;
determining a difficulty of the task based on a comparison of the task, the task result, and the task patterns and corresponding levels of difficulty; and
generating AR content based on the task and the difficulty of the task.
